(19) United States
(12) Patent Application Publication
(10) Pub. No.: US 2025/0188391 A1
(43) Pub. Date: Jun. 12, 2025

(54) CONTINUOUS PRODUCTION OF DRIED MALTED GRAINS

(71) Applicant: HEINEKEN SUPPLY CHAIN B.V., Zoeterwoude (NL)

(72) Inventors: Johan Franciscus Maria VISSENAEKENS, Zoeterwoude (NL); Hendrik Jan VISSCHER, Zoeterwoude (NL); Augustinus Cornelius Aldegonde Petrus Albert BEKKERS, Zoeterwoude (NL)

(21) Appl. No.: 19/061,220

(22) Filed: Feb. 24, 2025

Related U.S. Application Data
(63) Continuation of application No. PCT/EP2023/074342, filed on Sep. 5, 2023.

(30) Foreign Application Priority Data
Sep. 6, 2022 (EP) 22194206.3

(51) Int. Cl. C12C 1/135; A23L 7/20; C12C 1/02; C12C 1/047; C12C 1/12

(52) U.S. Cl. CPC C12C 1/135; A23L 7/20; C12C 1/02; C12C 1/047; C12C 1/12

(57) ABSTRACT

A continuous method of producing dried malted grains is disclosed. The method comprises: (a) providing a continuous stream of steeped grains having a water content of at least 30 wt. %; (b) transporting the stream through a germination stage to produce a continuous stream of malted grains, the germination stage comprising (i) maintaining the grains at 10-30° C. and (ii) maintaining the water content of the grains within the range of 20-38 wt. %, the residence time of the grains in the germination stage being in the range of 12 to 36 hours; (c) transporting a layer of the malted grains with a second moving conveyor through a drying stage to produce a continuous stream of dried malted grains, the residence time of the grains in the drying stage being in the range of 2 to 24 hours. Also disclosed is a dried malted barley that is obtained by the aforementioned method.

### CROSS-REFERENCE TO RELATED APPLICATIONS

This application is a continuation of International Patent Application No. PCT/EP2023/074342 filed Sep. 5, 2023, which claims priority to European Patent Application No. 22194206.3 filed Sep. 6, 2022, the entire disclosures of which are incorporated by reference herein.

### TECHNICAL FIELD OF THE INVENTION

The present invention relates to a continuous method of producing dried malted grains, said method comprising

a) providing a continuous stream of steeped grains;

b) transporting the stream of steeped grains through a germination stage to produce a continuous stream of malted grains; and

c) transporting the stream of malted grains with a second moving conveyor through a drying stage to produce a continuous stream of dried malted grains.

The invention further provides a chit malt that has been processed very homogenously, resulting in a chit malt that combines a relatively high moisture content with excellent stability.

### BACKGROUND OF THE INVENTION

Malt is germinated cereal grain that has been produced in a process known as “malting”.

Malting is a process of steeping, germinating, drying and deculming grain to convert it into malt. The main purpose of the malting process is to develop the endogenous enzymes α-amylase and β-amylase. These enzymes catalyse the conversion of starch into fermentable sugars when malt is used to produce a wort, i.e. the liquid extracted from the mashing process during the brewing of beer or whisky. Various grains are used for malting; the most common are barley, sorghum, wheat and rye. The malted grains obtained by malting barley or rye still contain the outer husk.

Steeping is the start of the malting process and comprises the addition of steep water to cover the grain to increase the moisture content of the grain to between 44 and 46%. In a modern pneumatic malt house, the grain is alternatively submerged (wet stand) and then drained (an air rest) for one, two or three cycles to achieve the target grain moisture content and the desired chit count. The chit is the first sign of the emerging rootlets. At the end of steeping the grain is cast-out to germination.

The aim of germination is to sprout the grains. During sprouting, malt enzymes are activated and these enzymes start modifying the structure of the barley endosperm by breaking down the cell walls and the protein matrix. Germination produces a large amount of heat. The grain bed is maintained at a constant temperature of between 10 and 16° C. by the constant supply of fresh humidified air and turners move through the grain bed to keep it loose to allow for sufficient air-flow. Germination typically takes 4-6 days and results in what is called “green malt”.

Kilning reduces the grain moisture content of the green malt and stops the germination process. In the first stage, the free drying stage, the air temperature is kept cool to dry the grain without causing the enzymes to denature. As the grain dries it is possible to raise the air temperature (the second stage or the forced drying stage) to further dry the grain without inactivating the amylase enzymes. The target malt moisture after kilning is around 4 to 5% by weight. During the last few hours of kilning the air temperature is raised to above 80° C. (the curing stage) to break S-methyl methionine down to dimethyl sulphide to reduce the dimethyl sulphide potential of the malt. Dimethyl sulphide is an off flavour that tastes like cooked vegetable and/or cabbage in the final beer.

During kilning, the layer of green malt is left undisturbed. As a result the moisture content within the layer forms a gradient, i.e. the lowest moisture content is observed at the bottom of the layer where hot air enters the layer and the higher moisture content is observed at the top of the layer. Typically the layer of green malt that is subjected to killning has a thickness of 60-200 cm. Thus, the malted grains in the bottom of the layer suffer substantially more heat exposure than the malted grains in the top layer, causing a wide spread in e.g. amylase activity between these malted grains.

Deculming is the term used for the removal of rootlets of the malt. Deculming is normally carried out shortly after transfer from the kiln.

“Chit malt” is a special type of malt that differs from ordinary malt in that it is obtained by a process that employs a shortened germination period of typically 1-2 days. In comparison to ordinary malt, the alpha-amylase activity of chit malt is considerably lower.

U.S. Pat. No. 4,004,034 describes a process for the manufacture of a wort which comprises subjecting barley to at least one treatment cycle comprising a steeping in water followed by exposure to air, the conditions of temperature and the duration of the stages of this cycle being chosen to cause chitting of the barley to form chit malt and to promote the development of a maximum enzymatic potential, rolling the chit malt, drying the rolled chit malt to stop the development of the biological processes occurring in it while retaining its enzymatic potential, grinding the dried and rolled chit malt and extracting it with a mixture of hot water and malt, the quantity of malt being 10 to 40% by weight on a solids basis of the dry weight of the mixture of ground chit and malt, and separating the wort so produced.

U.S. Pat. No. 2,998,351 describes a process of malting grain which comprises continuously forming and moving a bed of grain in a pre-determined path, subjecting said moving grain to a period of water spray until it attains a moisture content of approximately 32 to 35% (on a wet basis), resting said moving bed from spray for a further period sufficient for the grain to sprout and to rupture the seed coat, and then subjecting said moving bed to a plurality of periods (a) of spraying with water and (b) conditioned aeration so as to attain a moisture content within the range of 40 to 50% (on a wet basis), said periods of treatment being carried cut at temperatures between 50 and 100° F. and finally subjecting said moving bed to a period of drying at higher temperatures.

WO 99/45092 describes a process for the continuous malting of cereal grains, in which grains provided by a feeding device flow down through conveyor passages under the influence of gravity with alternating direction of movement and are exposed to aeration, cooling, wetting and drying media before being discharged as malt, characterized in that in the transfer area between two conveyor passages the downward flowing grain is divided in at least in at least one upper substream and one lower substream and that these substreams are subsequently merged again.

WO 99/45093 describes a method for continuous malting, wherein the grains, preferably coming from day cells, continuously pass through the following stages in any order: weighing, sieving, chafing, separating the light material, sorting, washing, scouring and wet steeping and dry steeping, following which the steeped grains are conveyed to a production unit for continuous malting.

WO 2018/193168 describes a continuous malting process, using a germinating or kilning tunnel, in which:
malt is moved through an upper channel of the tunnel comprising a superimposed lower channel and higher channel, by an entrainment chain transporting the malt through the upper channel, the malt and the entrainment chain resting on a grid with elongated openings, separating the lower channel and the upper channel,.
the chain returns through the low channel,
air is brought in through the lower channel, crosses through the grid and enters the upper channel,
by-products fall through the openings of the grid and are evacuated entrained by the chain return in the direction opposite to the direction of malt entrainment,.
and the air supply is cut off by a removable panel mounted in the bottom channel above the chain return.

### SUMMARY OF THE INVENTION

The inventors have developed a novel method for the continuous production of dried malted grains that requires much less energy, time and water than conventional production methods.

The continuous method of producing dried malted grains according to the present invention comprises:

a) providing a continuous stream of steeped grains having a water content of at least 30 wt. %;

b) transporting the stream of steeped grains through a germination stage to produce a continuous stream of malted grains, said germination stage comprising (i) maintaining the grains at a temperature in the range of 10-30° C. and (ii) maintaining the water content of the grains within the range of 20-38 wt. %, the residence time of the grains in the germination stage being in the range of 12 to 36 hours;

c) transporting a layer of the malted grains with a second moving conveyor through a drying stage to produce a continuous stream of dried malted grains, said drying stage comprising contacting the grains with a stream of hot air that reaches a maximum temperature of at least 50° C. during the drying stage during the drying stage, the residence time of the grains in the drying stage being in the range of 2 to 24 hours.

The present method is characterized by a low uptake of water by the steeped grains and by a short germination stage. Since also during the germination stage the water content of the grains is maintained at a low level of 20-38 wt. %, the amount of energy and time required for drying of the malted grains is substantially reduced.

The present method offers the advantage that both germination and drying can be achieved using a thin layer of grains. As a result the method enables the production of a dried malt that is very homogeneous in appearance (colour, chit length), water activity and enzyme activity.

The continuous malting method of the present invention enables the production of chit malt that is extremely homogeneous in terms of moisture content. Accordingly, the present invention also provides a dried malted barley that is obtained or obtainable by the present method, said dried malted barley having the following combination of features:
an alpha-amylase activity of 1-58 Dextrinizing Units (DU) per gram of dry matter, as determined by EBC method 4.13 (Alpha-amylase Content of Malt);
a moisture content of 6.0-8.0 wt. %, as determined by EBC method 4.2 (Moisture Content of Malt);

wherein at least 95% of the grains in the dried malted barley have a moisture content that differs by not more than 1.0 wt. % from the moisture content of the dried malted grain.

The dried malted grain of the present invention may suitably be used in the production of malt beverages such as beer and whiskey.

### DETAILED DESCRIPTION OF THE INVENTION

A first aspect of the present invention relates to a continuous method of producing dried malted grains, said method comprising:

a) providing a continuous stream of steeped grains having a water content of at least 30 wt. %;

b) transporting the stream of steeped grains through a germination stage to produce a continuous stream of malted grains, said germination stage comprising (i) maintaining the grains at a temperature in the range of 10-30° C. and (ii) maintaining the water content of the grains within the range of 20-38 wt. %, the residence time of the grains in the germination stage being in the range of 12 to 36 hours, wherein the stream of steeped grains is preferably transported through the germination stage (i) as a layer of steeped grains with a first moving conveyor or (ii) as a stream of steeped grains that travels downwards through a germination tower under the influence of gravity;

c) transporting a layer of the malted grains with a second moving conveyor through a drying stage to produce a continuous stream of dried malted grains, said drying stage comprising contacting the grains with a stream of hot air that reaches a maximum temperature of at least 50° C. during the drying stage, the residence time of the grains in the drying stage being in the range of 2 to 24 hours.

The term “grain” as used herein refers to cereal grains that are harvested for human consumption. Examples of grains include barley, oat, rice, rye, wheat, maize and sorghum. The term “steeping” as used herein refers to a procedure in which grains are covered with steep water to increase the moisture content of the grain ('wet stand'). The wet stands may be interrupted by so called ‘dry stands’, during which the water is drained out and fresh air may be supplied to remove excess carbon dioxide.

The term “germinating” as used herein refers to the procedure in which a bed of steeped grains is allowed to germinate under humid conditions.

The term “chit” as used herein refers to the initial growth phase of the malt rootlets

The term “malted” as used herein refers to grains that have germinated to the extent that they have formed a chit.

The term “malt” as used herein refers to malted grains that have been dried.

The term “chit malt” as used herein refers to a malt that has been obtained by germinating barley during a period of 12 hours to 36 hours. During this germination step, alpha-amylase is activated.

The term “husk” as used herein refers to the outer layer of barley grains that surrounds the pericarp layer.

The term “dehusking” as used herein refers to the application of abrasion and/or friction to remove husk from non-malted grains. Dehusking can be done, for instance, by using a polisher/dehusker/dehuller in which the grains are passed between rotating drum devices, or by using pearling equipment which typically employs grinding stones to peel the husk from the grain.

The term “peeling” as used herein refers to the application of abrasion and/or friction to remove husk from malted grains. Peeling can be done, for instance, by using pearling equipment which typically employs grinding stones, or by using a polisher/dehusker/dehuller (or a combination thereof) in which husk is removed by passing the malt between rotating drums or rollers.

The term “beer” as used herein refers to a yeast fermented malt beverage that has optionally been hopped. Beer is commonly produced by a process that comprises the following basic steps:
mashing a mixture comprising malted grains, preferably malted barley, optionally supplementary grains and water to produce a mash;
separating the mash in wort and spent grains;
boiling the wort to produce a boiled wort;
fermenting the boiled wort with live yeast to produce a fermented wort;
subjecting the fermented wort to one or more further process steps (e.g. maturation and filtration) to produce beer; and
packaging the beer in a sealed container, e.g. a bottle, can or keg.

Hop or hop extract is usually added during wort boiling to produce hopped beer. Depending on the beer style and brewing facility, the employed hopping method and timing may vary.

The present method may be used to produce dried malted grains from husked grains as well as from naked grains. The grains that are malted in the present continuous method are preferably selected from barley grains, sorghum grains, wheat grains, rye grains and combinations thereof.

Most preferably, the grains employed in the present method are barley grains (Hordeum vulgare).

In accordance with a particularly preferred embodiment, the continuous stream of steeped grains is produced by steeping dry grains having a water content of less than 18 wt. %, more preferably of 10-16 wt. %.

The steeping of the dry grains is preferably carried out in a continuous manner. Continuous steeping of the dry grains may suitably be achieved by transporting the grains through one or more screw conveyors (e.g. washing screws, sweeping augers) in which the grains are combined with steeping water to produce the steeped grains.

The steeping water used for steeping the grains preferably has a temperature of 10-35° C., more preferably of 15-25° C. and most preferably of 18-20° C.

Preferably, the total steeping time is at least 8 hours, more preferably 8-24 hours and most preferably 14-20 hours.

At the beginning of stage b) of the present method, the steeped grains preferably have a water content of 30-38 wt. %, more preferably a water content of 31-36 wt. % and most preferably a water content of 32-35 wt. %.

The present method may employ different types of continuous germinators for carrying out the germination stage. In accordance with one embodiment of the invention, a layer of the steeped grains is transported by a moving conveyor through the germination stage. The steeped grains are preferably transported through the germination stage in a layer having an average thickness of 10-60 cm, more preferably of 15-50 cm and most preferably of 20-30 cm.

The moving conveyor used in the germination stage b) is preferably selected from conveyor belts and entrainment chains. Here the term “entrainment chain” refers to an interlinked chain of receptacles, said receptacles having an open underside which is closed off by a flat sliding surface onto which the receptacles rest, and wherein the chain of receptacles forms a closed loop and the receptacles can be transported across the sliding surface by one or more driving pulleys.

Most preferably, the moving conveyor used in stage b) is a conveyor belt. According to a particularly preferred embodiment, the conveyor belt has small through openings that together cover at least 10%, more preferably 15-70% and most preferably 20-40% of the total surface area of the conveyor belt. The through openings are preferably sufficiently small to prevent the grains from falling through. In a preferred embodiment, a stream of cool, humid air is blown through the through openings in the conveyor belt during the germination stage. Most preferably, the cool, humid air is blow upwards through the openings of the conveyor belt. The stream of cool, humid air preferably has a temperature in the range of 10-30° C., more preferably in the range of 15-27° C. The stream of humid air preferably has a relative humidity of at least 80%, more preferably of at least 90%.

In accordance with an alternative embodiment of the present method, the continuous germinator used for carrying out the germination stage is a tower through which the steeped grains travel downwards under the influence of gravity. The tower typically comprises one or more vertically stacked chambers in which temperature, moisture, oxygen and carbon dioxide concentrations are controlled to promote germination.

According to a particularly preferred embodiment, the grains are agitated during at least a part of germination stage b). Agitation may be achieved by, for instance, raking, stirring, vibration, dropping (e.g. dropping onto a moving belt) and/or gas flow.

Temperature and humidity are the prime factors determining the speed of germination. In the present method, during the germination stage b), the grains are preferably maintained at a temperature in the range of 15-35° C., more preferably in the range of 20-32° C., and more preferably in the range of 22-30° C.

During the germination stage b) the water content of the grains is preferably maintained between 25 and 38 wt. %, more preferably between 28 and 36 wt. % and most preferably between 30 and 35 wt. %. In order to maintain the water content within these ranges, water may be sprayed onto the layer of steeped grains during the germination stage.

During the germination stage b), the grains are preferably exposed to an air flow so as to ensure that sufficient oxygen is available for aerobic respiration.

The residence time of the grains in the germination stage preferably is in the range of 12-36 hours, more preferably in the range of 18-32 hours and most preferably in the range of 20-30 hours.

The malted grains are preferably transported through the drying stage c) in a layer having an average thickness of 5-50 cm, more preferably of 10-40 cm and most preferably of 15-25 cm.

The present method enables drying of malted grains in a relatively thin layer. As a result variations in water content, colour and amylase activity can be minimised effectively.

During the drying of the malted grains, the temperature of the stream of hot air is preferably increased during the drying process. According to a particularly preferred embodiment, the stream of hot air that is used to dry the malted grains reaches a maximum temperature of at least 55° C., more preferably a maximum temperature in the range of 60-90° C. during the drying stage. Here the temperature of the hot air refers to the temperature of the hot air immediately before it comes into contact with the malted grains.

The residence time of the grains in the drying stage preferably is in the range of 2-12 hours, more preferably in the range of 2.3-10 hours and most preferably in the range of 2.5-6hours.

The moving conveyor used in the drying stage c) is preferably selected from conveyor belts and entrainment chains. More preferably, the moving conveyor used in stage c) is a conveyor belt. According to a particularly preferred embodiment, the conveyor belt has small through openings that together cover at least 10%, more preferably 15-70% and most preferably 20-40% of the total surface area of the conveyor belt. The through openings are preferably sufficiently small to prevent the grains from falling through. Preferably, at least a part of the stream of hot air is blown through the through openings of the conveyor belt. Most preferably, the hot air is blow upwards through the openings of the conveyor belt.

During the drying stage c), the malted grains are preferably dried to a moisture content of less than 18 wt. %, more preferably to a moisture content of 3-16 wt. % and most preferably to a moisture content of 5-15 wt. %.

The total residence time of the grains in the germination and drying stages of the present method is preferably in the range of 15-45 hours, more preferably in the range of 18-40 hours and most preferably in the range of 22-35 hours.

According to further preferred embodiment, the present method does not comprise a deculming step.

The dried malted grains obtained by the present method preferably have an alpha-amylase activity of 1-58 Dextrinizing Units (DU) per gram of dry matter, as determined by EBC method 4.13. More preferably, the alpha-amylase activity is in the range of 1-50, more preferably in the range of 2-35, even more preferably in the range of 3-32, and most preferably in the range of 4-30 Dextrinizing Units (DU) per gram of dry matter as determined by EBC method 4.13.

The Kolbach Index of the dried malted grains that are obtained by the present method preferably is 5-35%, as determined by EBC method 4.9.3. More preferably, the Kolbach Index is in the range of 8-30%, most preferably in the range of 10-25%.

According to a particularly preferred embodiment of the present method, the grains employed are naked grains or husked grains that are dehusked prior to steeping. Preferably, the dehusking is achieved by mechanically removing the husk.

Dehusking of the husked grains has the advantage that it takes less time to achieve adequate steeping and that the overall water uptake is reduced. As a result, also the amount of energy and time required for drying is reduced.

Dehusking of the grains is preferably achieved by passing the barley through a dehusking machine comprising one or more rotatable abrasive rollers. Preferably, the dehusking machine comprises two or more rotatable abrasive rollers that apply friction to grains that pass through the gap between these rollers by rotating at different speeds.

According to a particularly preferred embodiment, the grains are not completely dehusked prior to malting. Complete dehusking may damage the embryo of the barley grains, causing the barley grains to lose the ability to germinate.

During the dehusking, the grains preferably undergo a weight reduction of 1-14%, more preferably of 1.5-12%, most preferably of 2-10%.

The inventors have found that the dried malted grain obtained by the continuous malting method of the present invention are relatively hard. Typically, the dried malted grain has a friability of at least 20, more preferably at least 23 and most preferably of 25 to 35 as determined by EBC method 4.15 (Friability, Glassy Corns and Unmodified Grains of Malt by Friabilimeter (IM)).

Due to the low friability of the dried malted grains that are obtained by the present method, it is relatively easy to remove the husk without causing the endosperm to crumble. By peeling the dried malted grain, the bulk density of the malted grain can be increased significantly. Thus, in comparison to ordinary malt, the space and energy required for transportation and storage of the peeled dried malted grain are reduced substantially. Accordingly, in another preferred embodiment, the present method comprises the step of peeling the dried malted grain to remove husk and to produce a peeled malted grain.

During the peeling, the dried malted grains preferably undergo a weight reduction of 1-14%, more preferably of 2-12%, most preferably of 2.5-10%.

Another aspect of the invention relates to a dried malted barley that is obtained or obtainable by the present method, said dried malted barley having the following combination of features:
an alpha-amylase activity of 1-58 Dextrinizing Units (DU) per gram of dry matter, as determined by EBC method 4.13 (Alpha-amylase Content of Malt);
a moisture content of 6.0-8.0 wt. %, as determined by EBC method 4.2 (Moisture Content of Malt);

wherein at least 95% of the grains in the dried malted barley have a moisture content that differs by not more than 1.0 wt. % from the moisture content of the dried malted grain. Here the wt. % difference in moisture content refers to the absolute difference in moisture content. In other words, the difference in moisture content between a grain having a moisture content of 6.8 wt. %

and a malted barley grain having a moisture content of 7.0 wt. % is 0.2 wt. %.

In order to establish the percentage of grains that has a moisture content inside the specified range, 100 grains are randomly collected from a batch of dried malted barley. The weight of each grain is accurately determined before and after rigorous dehydration. The moisture content of each grain is determined on the basis of the amount of water that was lost during dehydration. Rigorous dehydration is achieved by drying the intact malt grains at a temperature of 80° C. at reduced pressure. The drying time employed to achieve rigorous dehydration is determined beforehand by drying a sample containing at least 100 grains of dried malted barley under the aforementioned drying conditions until the weight of sample no longer decreases.

Preferably, the dried malted grains are obtained by the continuous method of the present invention.

According to a particularly preferred embodiment, the moisture content of the dried malted grain is in the range of 6.2-7.8 wt. %, most preferably in the range of 6.5-7.5 wt. %, as determined by EBC method 4.1.

The alpha-amylase content of the dried malted grain preferably is in the range of 2-40, most preferably of 4-32 Dextrinizing Units (DU) per gram of dry matter as determined by EBC method 4.13.

The dried malted grains preferably have an alpha-amylase activity of 1-50 Dextrinizing Units (DU) per gram of dry matter, as determined by EBC method 4.13. More preferably, the alpha-amylase activity is in the range of 2-35, even more preferably in the range of 3-32, and most preferably in the range of 4-30 Dextrinizing Units (DU) per gram of dry matter as determined by EBC method 4.13.

The Kolbach Index of the dried malted grains that preferably is 5-35%, as determined by EBC method 4.9.3. More preferably, the Kolbach Index is in the range of 8-30%, most preferably in the range of 10-25%.

According to a particularly preferred embodiment, at least 95% of the grains in the dried malted barley have a moisture content that differs by not more than 0.8 wt. %, more preferably by not more than 0.6 wt. %, even more preferably by not more than 0.4 wt. % and most preferably by not more than 0.3 wt. % from the moisture content of the dried malted grain.

Yet another aspect of the invention relates to a method of producing a malt beverage, said method comprising:
providing a mixture comprising malt and water, wherein at least 1 wt. % of the malt are dried malted grains according to the present invention;
mashing the mixture to convert starch into fermentable sugars and to produce a mash containing fermentable sugars; and
subjecting the mash containing fermentable sugars to a solid-liquid separation to separate wort from insoluble matter.

Preferably at least 10 wt. %, more preferably at least 20 wt. %, most preferably at least 40 wt. % and most preferably 100 wt. % of the malt in the mixture comprising malt and water is barley malt.

Preferably at least 3 wt. %, more preferably at least 5 wt. %, even more preferably at least 8 wt. % and most preferably at least 10 wt. % of the malt in the mixture comprising malt and water are the dried malted grains according to the present invention.

The mixture comprising malt and water preferably does not comprise adjuncts.

The separation of the mash into wort and insoluble matter may suitably be carried out in a lauter tun, a mash tun, a centrifuge, a mash filter.

In a particularly preferred embodiment, the solid-liquid separation of the mash comprises filtering of the mash through a filter bed that comprises at least 80 wt. %, more preferably at least 90 wt. % and most preferably 100 wt. % of insoluble material originating from the malt. Examples of devices that may be used for such filtration include a lautertun and a mash tun.

In a preferred embodiment, the present method yields a wort that is 100% malt based.

According to a particularly preferred embodiment, the wort is further processed to produce a malt beverage in the form of beer or whiskey, said further processing comprising the step of subjecting the wort to a yeast fermentation. Preferably the fermentation is a bottom fermentation.

The invention is further illustrated by the following non-limiting examples.

### EXAMPLES

### Example 1

7 kg of barley (2 rowed spring barley, origin France) was steeped for 6 hours at 10° C. to produce steeped barley having a water content of 35 wt. %.

Next, the steeped barley was allowed to germinate for 18 hours in a layer having a thickness of approximately 25 cm, to produce malted barley having a moisture content of 35 wt. %.

The malted grains were dried on a belt drier to a moisture content of 7.7 wt. % in 4.5 hours. The drying conditions were as follows:
Layer thickness: 20 cm
Air velocity: 0.6 m/s
Temperature program:
   30 minutes at 45° C.;
   45 minutes at 62° C.;
   75 minutes heating a constant heating rate to 80° C.;
   120 minutes at 80° C.;

The dried malt so obtained was analysed. The results of the analysis are summarised in Table 1.

TABLE 1

| | |
|---|---|
| Alpha amylase on dry matter (UD/g) | 15 |
| Beta amylase on dry matter (units/g) | 8.9 |
| Beta glucanase on dry matter (U/kg) | 4.1 |
| Colour of wort (EBC) | 2.5 |
| Extract as adjunct on dry matter | 83.9 |
| (%(m/m)) | |
| Limit dextrinase activity on dry | 9.1 |
| matter (U/kg) | |
| Lipoxygenase activity on dry matter | 51.4 |
| (UA/min/g MS) | |
| Kolbach Index (in %) | 21 |
| Soluble protein on dry matter | 2.0 |
| Total polyphenols (mg/l) | 58 |
| Protein on dry matter (%) | 9.8 |
| Total DMS on dry matter(mg/kg) | 0.80 |

### Example 2

Chit malt is produced from barley grain in a continuous method according to the present invention.

Barley grains are continuously steeped with steeping water having a temperature of 22° C. as follows. The barley is washed and soaked in a first washing screw, following which the soaked barley undergoes a dry steeping stage in a first rest tank that is continuously filled and emptied in a first-in-first out (FIFO) manner to ensure homogeneous processing. The dry steeped barley obtained from the first rest tank is subsequently soaked in a second washing screw and subjected to a combination of dry stand and wet steep immersion in a second rest tank that is also operated in a FIFO manner. Both rest tanks are equipped with spraying devices and bottom outlets for water recirculation or draining. Total residence time in the first combination of washing screw and rest tank is 8 hours. Total residence time in the second combination of washing screw and rest tank is 4-8 hours. At the end of the steeping stage, the water content of the steeped grains is about 35 wt. %.

The steeped grains are continuously transferred to the germination stage by off-loading the steeped grains onto a first conveyor belt that is mounted in a closed housing that contains two more identical conveyor belts. The three conveyor belts are located above each other so that at the end of the moving conveyor belt grains are dropped onto the moving conveyor belt below. During the germination stage the grains remain distributed across the conveyor belts to form a layer having an average thickness of about 50 cm. Each conveyor belt has small through openings that cover 33% of the belt. A continuous upward flow of humidified air is maintained during the germination stage. The humidified air has a temperature of about 20° C. The water content of the grains is maintained at about 35 wt. % by spraying the layer of grains with water at regular intervals. The total residence time of the grains on the conveyor belts is about 24 hours. The water content of the malted grains at the end of the germination stage is about 35 wt. %. The percentage of chitted grains exceeds 85%

After germination, the malted grains are continuously transferred to the drying stage that comprises three successive phases:
withering stage;
breakpoint drying stage
curing drying stage

Each of the three successive drying phases is carried out in a belt dryer that comprises a conveyor belt having small through openings that cover 33% of the belt. The drying conditions during each of the phases are summarised below.

### Withering Phase

product layer thickness: 10-15 cm
drying air temperature: 45-55° C.
residence time: 30-60 minutes.
Moisture content at the end of withering phase: 28-30%

### Breakpoint Drying Phase

product layer thickness: 14-28 cm
drying air temperature: 60-70° C.
residence time: 45-90 minutes
Moisture content at the end of breakpoint drying phase: 17-20%

### Curing Drying Phase

product layer thickness: 22-36 cm
drying air temperature: 70-80° C.
residence time: 75-120 minutes
Moisture content at the end of curing drying phase: <10%

### Example 3

Barley (2 rowed spring barley, origin France) is dehusked in batches of 100 grams in a Satake Test Mill (TM05C (2)-T). The total amount of material removed during dehusking is 6.7 wt. %.

The dehusked barley so obtained is converted into dried malted barley using a continuous malting process as described in Example 2. The total amount of water that is absorbed during steeping and the total amount of water that needs to be removed during drying, calculated by weight of the non-dehusked barley is substantially lower than in the process of Example 2.

### Example 4

The chit malt obtained by the process that is described in Example 2 is peeled in batches of 100 grams in a Satake Test Mill (TM05C (2)-T). The total amount of material removed by peeling is about 14 wt. %. The extract content (EBC 6.4) of the malt is substantially increased as a result of the peeling.

1. A continuous method of producing dried malted grains, the method comprising:
(a) providing a continuous stream of steeped grains having a water content of at least 30 wt. %;
(b) transporting the stream of steeped grains through a germination stage to produce a continuous stream of malted grains, the germination stage comprising:
(i) maintaining the grains at a temperature in the range of 10-30° C. and
(ii) maintaining the water content of the grains within the range of 20-38 wt. %, the residence time of the grains in the germination stage being in the range of 12 to 36 hours,
wherein the stream of steeped grains is optionally transported through the germination stage (i) as a layer of steeped grains with a first moving conveyor or (ii) as a stream of steeped grains that travels downwards through a germination tower under the influence of gravity; and
(c) transporting a layer of the malted grains with a second moving conveyor through a drying stage to produce a continuous stream of dried malted grains, the drying stage comprising contacting the grains with a stream of hot air that reaches a maximum temperature of at least 50° C. during the drying stage, the residence time of the grains in the drying stage being in the range of 2 to 24 hours.

2. The continuous method according to claim 1, wherein the grains are selected from barley grains, sorghum grains, wheat grains, rye grains and combinations thereof.

3. The continuous method according to claim 1, wherein the continuous stream of steeped grains is produced by transporting dry grains having a water content of less than 18 wt. % through a screw conveyor in which the grains are combined with water to produce the steeped grains.

4. The continuous method according to claim 1, wherein the steeped grains have a water content of 25 wt. % to 38 wt. %.

5. The continuous method according to claim 1, wherein the steeped grains are transported through the germination stage in a layer having an average thickness of 10-30 cm.

6. The continuous method according to claim 1, wherein the layer of grains is agitated during at least a part of the germination stage (b).

7. The continuous method according to claim 1, wherein during transporting (b) the water content of the grains is maintained between 28 wt. % and 36 wt. %.

8. The continuous method according to claim 1, wherein the moving conveyor used in (b) and/or (c) is selected from conveyor belts and entrainment chains.

9. The continuous method according to claim 8, wherein the moving conveyor used (c) is a conveyor belt that has small through openings that together cover at least 10% of the total surface area of the conveyor belt, and at least a part of the stream of hot air is blown through these small openings.

10. The continuous method according to claim 1, wherein the malted grains are transported through the drying stage in a layer having an average thickness of 5-50 cm.

11. The continuous method according to claim 1, wherein the malted grains are dried to a moisture content of less than 18 wt. %.

12. The continuous method according to claim 1, wherein the dried malted grains obtained by the method have an alpha-amylase activity of 1-58 Dextrinizing Units (DU) per gram of dry matter, as determined by EBC method 4.13.

13. A dried malted barley obtained by the method according to claim 1 and having the following combination of features:
(i) an alpha-amylase activity of 1-58 Dextrinizing Units (DU) per gram of dry matter, as determined by EBC method 4.13 (Alpha-amylase Content of Malt); and
(ii) a moisture content of 6.0-8.0 wt. %, as determined by EBC method 4.2 (Moisture Content of Malt);
wherein at least 95% of the grains in the dried malted barley have a moisture content that differs by not more than 1.0 wt. % from the moisture content of the dried malted barley.

14. The dried malted barley according to claim 13, wherein the dried malted barley has a Kolbach Index of 5-35%, as determined by EBC method 4.9.3.

15. A method of producing a malt beverage, the method comprising:
(a) providing a mixture comprising malt and water, wherein at least 1 wt. % of the malt is dried malted grains according to claim 13;
(b) mashing the mixture to convert starch into fermentable sugars and to produce a mash containing fermentable sugars; and
(c) subjecting the mash containing fermentable sugars to a solid-liquid separation to separate wort from insoluble matter.
